(19) United States
(12) Patent Application Publication
(10) Pub. No.: US 2026/0145289 A1
(43) Pub. Date: May 28, 2026

(54) CUTTING TOOL POSITIONING DEVICE AND METHOD

(71) Applicant: INDUSTRIAL TECHNOLOGY RESEARCH INSTITUTE, Hsinchu (TW)

(72) Inventors: Yun-Chiao CHEN, Taichung City (TW); Yung-Chih LIN, Taichung City (TW)

(73) Assignee: INDUSTRIAL TECHNOLOGY RESEARCH INSTITUTE, Hsinchu (TW)

(21) Appl. No.: 18/999,415

(22) Filed: Dec. 23, 2024

(30) Foreign Application Priority Data
Nov. 27, 2024 (TW) 113145847

(51) Int. Cl. B23Q 15/22; B23Q 16/00; B23Q 17/00

(52) U.S. Cl. CPC B23Q 15/22; B23Q 16/005; B23Q 17/006

(57) ABSTRACT

A cutting tool positioning method, applicable for a chain-type tool magazine with a plurality of tool holders and a base, includes performing distance sensing along a sensing direction toward the plurality of tool holders, obtaining a time-sequential waveform signal corresponding to a continuous time period based on sensing data acquired by the distance sensing, converting the time-sequential waveform signal into a sinusoidal waveform signal, and determining a position offset of each of the plurality of tool holders according to a plurality of measured peak positions of the sinusoidal waveform signal and a plurality of preset peak positions. A cutting tool positioning device, applicable for a chain-type tool magazine comprising a plurality of tool holders and a base, includes a distance sensor and a signal processing device, wherein the distance sensor is disposed at the base, and the signal processing device is connected to the distance sensor.

### CROSS-REFERENCE TO RELATED APPLICATIONS

The present application is based on, and claims priority from, Taiwan (International) Application Serial Number 113145847, filed on Nov. 27, 2024, the disclosure of which is hereby incorporated by reference herein in its entirety.

### BACKGROUND

### 1. Technical Field

This disclosure relates to a cutting tool positioning device and method.

### 2. Related Art

A chain-type tool magazine is a tool storage and management device used in a numerical control machine, which is designed for fast and accurate tool replacement. The tool magazine typically employs a chain structure to arrange tools, allowing for the accommodation of various tools and selection based on demand.

### SUMMARY

According to an embodiment of this disclosure, a cutting tool positioning device, applicable for a chain-type tool magazine comprising a plurality of tool holders and a base, comprises a distance sensor and a signal processing device, wherein the signal processing device is connected to the distance sensor. The distance sensor is disposed at the base, and configured to perform distance sensing along a sensing direction toward the plurality of tool holders, wherein the sensing direction is different from a movement direction of the plurality of tool holders. The signal processing device is configured to obtain a time-sequential waveform signal corresponding to a continuous time period based on sensing data acquired by the distance sensing, convert the time-sequential waveform signal into a sinusoidal waveform signal, and determine a position offset of each of the plurality of tool holders according to a plurality of measured peak positions of the sinusoidal waveform signal and a plurality of preset peak positions.

According to an embodiment of this disclosure, a cutting tool positioning method, applicable for a chain-type tool magazine comprising a plurality of tool holders and a base, comprises performing distance sensing along a sensing direction different from a movement direction of the plurality of tool holders toward the plurality of tool holders through a distance sensor, obtaining a time-sequential waveform signal corresponding to a continuous time period based on sensing data acquired by the distance sensing, converting the time-sequential waveform signal into a sinusoidal waveform signal, and determining a position offset of each of the plurality of tool holders according to a plurality of measured peak positions of the sinusoidal waveform signal and a plurality of preset peak positions.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a structural block diagram illustrating a cutting tool positioning device according to an embodiment of the present disclosure;

FIG. 2 is a functional block diagram illustrating a signal processing device of a cutting tool positioning device according to an embodiment of the present disclosure;

FIG. 3 is a side view schematic diagram illustrating the set position of a distance sensor of a cutting tool positioning device according to an embodiment of the present disclosure;

FIG. 4 is a three-dimensional schematic diagram illustrating the set position of a distance sensor of a cutting tool positioning device according to an embodiment of the present disclosure;

FIG. 5 is a flowchart illustrating a cutting tool positioning method according to an embodiment of the present disclosure;

FIG. 6 is a flowchart illustrating waveform signal transformation in a cutting tool positioning method according to an embodiment of the present disclosure;

FIG. 7 is a flowchart illustrating eliminating jitter and noise in a time-sequential waveform signal to generate a processed waveform signal in a cutting tool positioning method according to an embodiment of the present disclosure;

FIG. 8 is a flowchart illustrating converting the processed waveform signal into a sinusoidal waveform signal through forward and reverse filtering in a cutting tool positioning method according to an embodiment of the present disclosure;

FIG. 9 is a flowchart illustrating using the offset of a tool holder to drive the tool holder in a cutting tool positioning method according to an embodiment of the present disclosure;

FIG. 10 illustrates a waveform signal change diagram during the waveform signal transformation process in a cutting tool positioning method of an embodiment of the present disclosure; and

FIG. 11 illustrates a schematic diagram of waveform signals used in the offset determination step in a cutting tool positioning method according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The cutting tool positioning device and method described below are applicable for a chain tool magazine comprising a plurality of tool holders and a base.

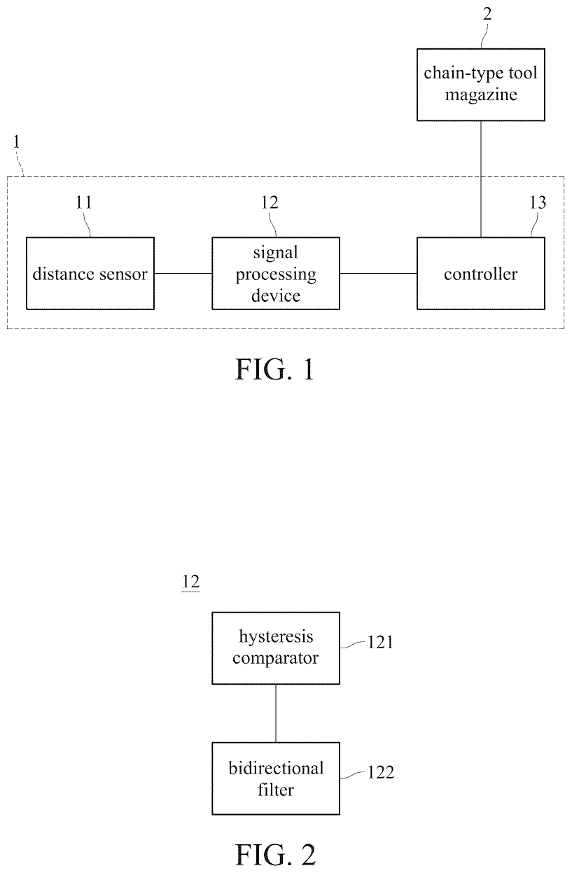

Please refer to FIG. 1, which is a structural block diagram illustrating a cutting tool positioning device according to an embodiment of the present disclosure. As shown in FIG. 1, the cutting tool positioning device 1 includes a distance sensor 11, a signal processing device 12, and a controller 13, wherein the controller 13 is optionally disposed. The signal processing device 12 is connected to the distance sensor 11 and/or the controller 13 via a wired or wireless mean, and the controller 13 is electrically connected to a chain-type tool magazine 2 via a wired mean.

The distance sensor 11 is configured to perform distance sensing along a sensing direction toward the plurality of tool holders of the chain-type tool magazine 2, wherein the sensing direction is different from a movement direction of the plurality of tool holders. For example, the distance sensor 11 may be, but is not limited to, a capacitive distance sensor, an infrared distance sensor, a laser rangefinder, or Hall sensor. The sensing direction may be perpendicular to the movement direction of the tool holders. By the distance sensing, the obtained measured distance values may outline the external shape of the tool holder shell as the tool holder passes by the distance sensor 11. In an embodiment, the sampling rate of the distance sensor 11 may be 1 kHz.

The signal processing device 12 is configured to obtain a time-sequential waveform signal corresponding to a continuous time period based on sensing data acquired by the distance sensing, convert the time-sequential waveform signal into a sinusoidal waveform signal, and determine a position offset of each of the plurality of tool holders according to a plurality of measured peak positions of the sinusoidal waveform signal and a plurality of preset peak positions. For example, the signal processing device 12 may include one or more processors, the processor is, for example, a central processing unit (CPU), a graphics processing unit (GPU), a microcontroller unit (MCU), a programmable logic controller (PLC), or other processors with signal processing functions. Specifically, the signal processing device 12 may receive sensing data from the distance sensor 11, and the sensing data may include measured distance values, wherein the measured distance values in a continuous time period may form a time-sequential waveform signal, such as a square wave, showing the shape of the shells of the plurality of tool holders as the plurality of tool holders pass by consecutively.

In an embodiment, the signal processing device 12 may be configured to eliminate jitter and noise from the time-sequential waveform signal to generate a processed waveform signal, and convert the processed waveform signal into the sinusoidal waveform signal through multiple times of filtering. In this embodiment, the signal processing device 12 may receive sensing data from the distance sensor 11 and convert the measured distance values measured over a continuous time period into a square wave through a time-sequential process, and the square wave may undergo forward filtering followed by reverse filtering to achieve a smooth sinusoidal waveform signal after filtering twice.

In an embodiment, the signal processing device 12 may be preset with a first threshold and a second threshold, and the signal processing device 12 eliminating jitter and noise from the time-sequential waveform signal may involve maintaining an output level unchanged when the measured distance value indicated by the sensing data is less than the first threshold and greater than the second threshold, outputting a first voltage level when the measured distance value is greater than or equal to the first threshold, and outputting a second voltage level lower than the first voltage level when the measured distance value is less than or equal to the second threshold. For example, the first threshold may be an upper threshold, such as 0.1 millimeters (mm), and the second threshold may be a lower threshold, such as −0.1 mm. The first threshold and the second threshold may depend on the length of each of the plurality of tool holders, for example, one-fifth of the length of the tool holder. After processing as described above, the plurality of measured distance values indicated by the sensing data may be converted into a square wave serving as the processed waveform signal.

In an embodiment, the signal processing device 12 performing a plurality of filtering on the processed waveform signal may involve performing forward filtering on the processed waveform signal to generate a forward filtering result, converting the forward filtering result into a reverse time sequence, performing the forward filtering on the reverse time sequence to generate a reverse filtering result, and reversing the reverse filtering result back to normal timing to produce the sinusoidal waveform signal. The operation of reversing the waveform signal and then performing forward filtering on the reversed waveform signal may be regarded as the operation of reverse filtering the waveform signal. Specifically, the forward filtering may be bandpass filtering. The forward filtering may have an order of 1, 2, or 3, a low cutoff frequency of 0.5 Hz, and a high cutoff frequency of 1 Hz. In an embodiment, the forward filtering has an order of 2, a lower cutoff frequency of 0.5 Hz, and a higher cutoff frequency of 1 Hz of the forward filtering. However, the filtering parameters of the present disclosure are not limited to the above-mentioned.

After obtaining the sinusoidal waveform signal, the signal processing device 12 may determine the position offset of each of the plurality of tool holders according to a plurality of measured peak positions of the sinusoidal waveform signal and a plurality of preset peak positions, and may store the position offset into the controller 13. The controller 13 may be configured to store the position offset of each of the plurality of tool holders, retrieve the position offset of one of the plurality of tool holders corresponding to input tool information, and drive the plurality of tool holders according to the position offset of the one of the plurality of tool holders. The controller 13 may include a control unit for controlling the chain movement to drive the tool holders and one or more processors. The processor may be, for example, a central processing unit (CPU), graphics processing unit (GPU), microcontroller, programmable logic controller (PLC), or other processors with computational capabilities. The processor may retrieve the position offset (target offset) corresponding to the input tool information from previously stored data, and the control unit may drive the tool holders based on the target offset. The input tool information may be the tool holder number or cutting tool number. The position offset may be measured in mm as unit.

Please refer to FIGS. 1 and 2. FIG. 2 is a functional block diagram illustrating a signal processing device of a cutting tool positioning device according to an embodiment of the present disclosure. As shown in FIG. 2, the signal processing device 12 of the cutting tool positioning device 1 may include a hysteresis comparator 121 and a bidirectional filter 122, which may be implemented in hardware or software. The hardware implementation of the bidirectional filter 122 may be connected to the hysteresis comparator 121 via wired or wireless means.

The hysteresis comparator 121 is configured to eliminate jitter and noise from the time-sequential waveform signal to generate a processed waveform signal. The hysteresis comparator 121 may be a Schmitt trigger, a zero-crossing comparator, or a voltage monitoring circuit with a hysteresis comparison function. The method of eliminating jitter and noise from the time-sequential waveform signal by the hysteresis comparator 121 may be as described in the above-mentioned embodiment and not be reiterated here.

The bidirectional filter 122 is configured to convert the processed waveform signal into the sinusoidal waveform signal through forward filtering and reverse filtering. In an embodiment, the bidirectional filter 122 may be a bandpass filter, such as a Butterworth bandpass filter. In another embodiment, the bidirectional filter 122 may be a Kalman filter, a bidirectional IIR filter, or a bidirectional adaptive filter capable of forward and reverse filtering. The method of performing multiple filtering processes on the processed waveform signal by the bidirectional filter 122 may be as described in the above-mentioned embodiment and not be reiterated here.

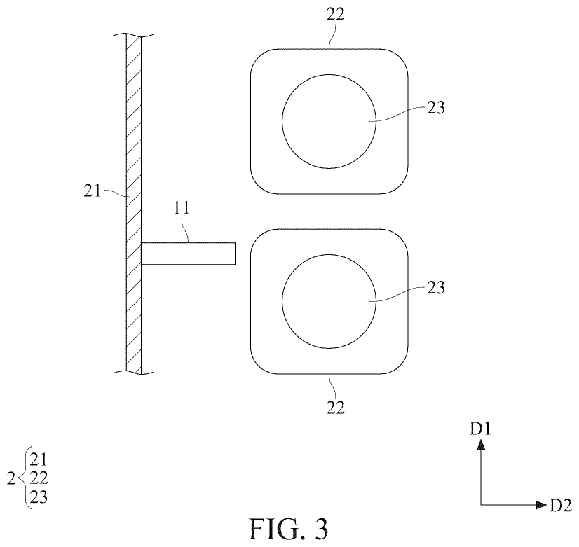

Please refer to FIG. 3, which is a side view schematic diagram illustrating the set position of a distance sensor of a cutting tool positioning device according to an embodiment of the present disclosure. As shown in FIG. 3, the chain-type tool magazine 2 includes a base 21, a plurality of tool holders 22, and a plurality of cutting tools 23. The distance sensor 11 of the cutting tool positioning device may be disposed at the base 21 to perform distance sensing toward the plurality of tool holders 22, which are equipped with the plurality of cutting tools 23, respectively. The implementation, function, and operation of the distance sensor 11 are the same as those described in FIG. 1 and not reiterated here.

In this embodiment, the base 21 may be disposed parallel to the movement direction D1 of the plurality of tool holders 22, the distance sensor 11 may be disposed at the base 21, and the sensing direction D2 is perpendicular to the movement direction D1 of the plurality of tool holders 22. The distance sensor 11 is configured to perform distance sensing along the sensing direction D2 toward the plurality of tool holders 22.

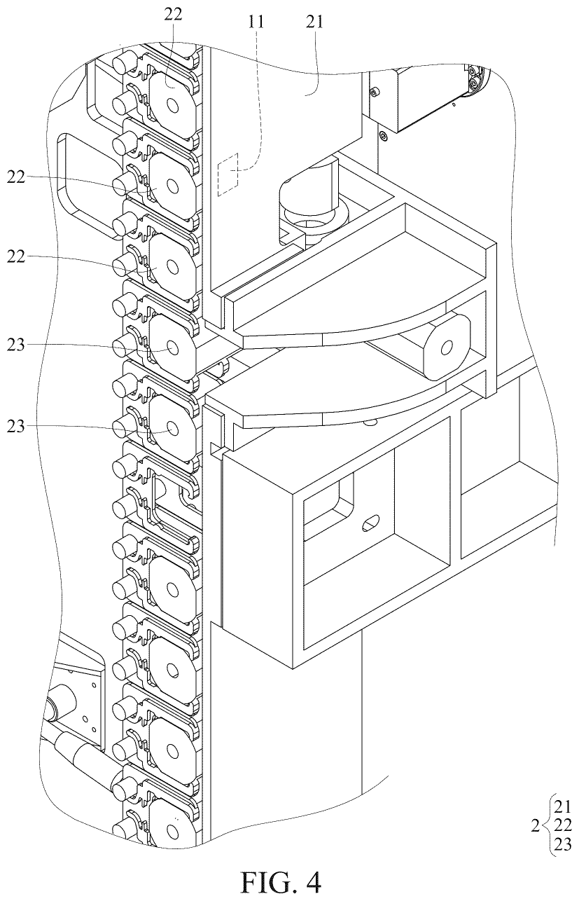

Please refer to FIG. 4, which is a three-dimensional schematic diagram illustrating the set position of a distance sensor of a cutting tool positioning device according to an embodiment of the present disclosure. As shown in FIG. 4, the chain-type tool magazine 2 includes a base 21, a plurality of tool holders 22, and a plurality of cutting tools 23. The distance sensor 11 of the cutting tool positioning device may be disposed on the inner side of the base 21 of the chain-type tool magazine 2, such as between the plurality of tool holders 22 equipped with the plurality of cutting tools 23 respectively and the base 21, to perform distance sensing toward the plurality of tool holders 22 (e.g., in a direction perpendicular to the base 21).

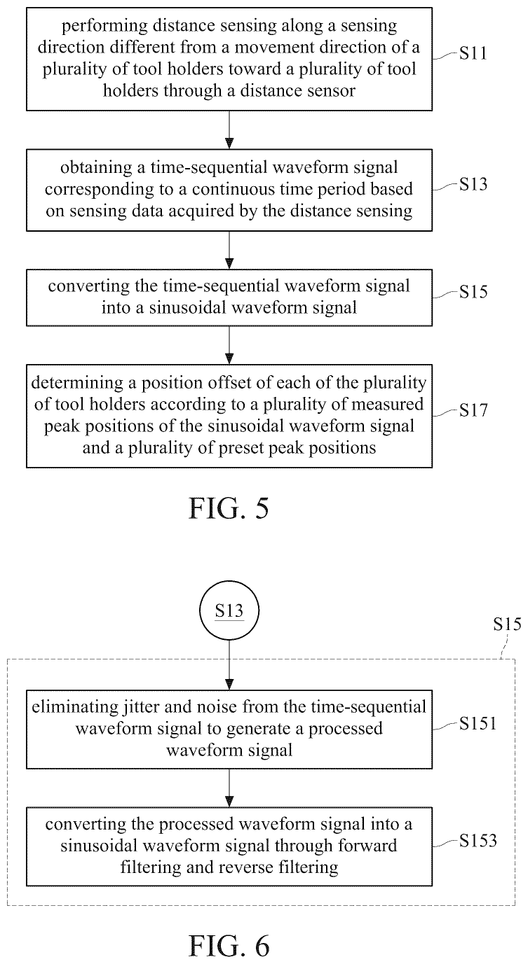

Please refer to FIG. 5, which is a flowchart illustrating a cutting tool positioning method according to an embodiment of the present disclosure. As shown in FIG. 5, the cutting tool positioning method, for example, implemented as software or firmware in the signal processing device 12, executes a series of steps including the following when the software or firmware read by a processor The series of steps include step S11: performing distance sensing along a sensing direction different from a movement direction of a plurality of tool holders toward the plurality of tool holders through a distance sensor; step S13: obtaining a time-sequential waveform signal corresponding to a continuous time period based on sensing data acquired by the distance sensing; step S15: converting the time-sequential waveform signal into a sinusoidal waveform signal; and step S17: determining a position offset of each of the plurality of tool holders according to a plurality of measured peak positions of the sinusoidal waveform signal and a plurality of preset peak positions. The tool positioning method is applicable for the cutting tool positioning device 1 shown in FIG. 1. The following exemplary description uses the cutting tool positioning device 1 shown in FIG. 1 and the set position schematic diagram shown in FIG. 3 to illustrate the cutting tool positioning method shown in FIG. 5.

In step S11, the distance sensor 11 performs distance sensing along a sensing direction D2 different from a movement direction D1 of the plurality of tool holders 22 toward the plurality of tool holders 22. Specifically, the sensing direction D2 may be perpendicular to the movement direction D1 of the tool holders 22. Through the distance sensing, the obtained measured distance values may outline the external shell shape of the plurality of tool holders 22 as the plurality of tool holders 22 pass by the distance sensor 11. In an embodiment, the sampling rate of the distance sensor 11 may be 1 kHz.

In step S13, the signal processing device 12 obtains a time-sequential waveform signal corresponding to a continuous time period based on sensing data acquired by the distance sensing. For example, the signal processing device 12 may receive the sensing data, which may include measured distance value, from the distance sensor 11. When the plurality of tool holders 22 pass by consecutively, the measured distance values in a continuous time period may form a time-sequential waveform signal representing the shell of a tool holder 22, such as a square wave.

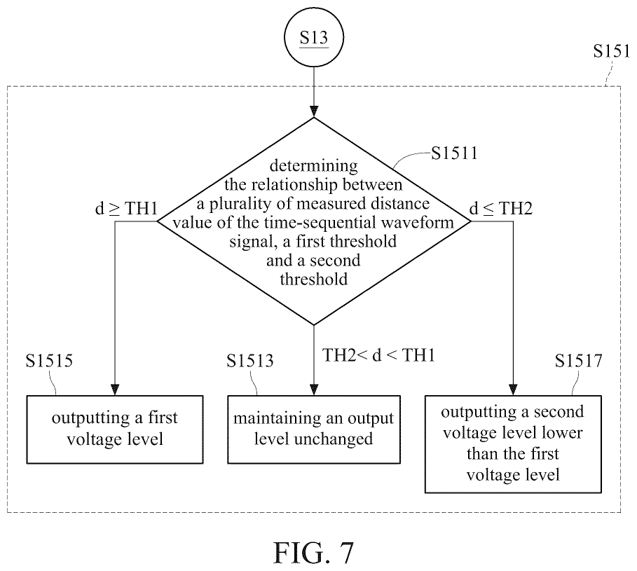

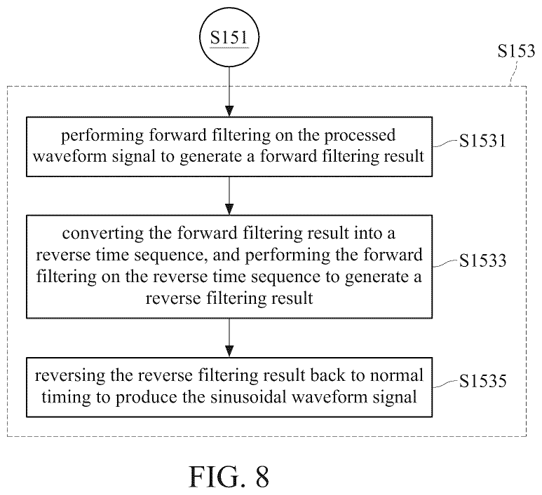

In step S15, the signal processing device 12 converts the time-sequential waveform signal into a sinusoidal waveform signal. To further illustrate step S15, please refer to FIGS. 6, 7, and 8. FIG. 6 is a flowchart illustrating waveform signal transformation in a cutting tool positioning method according to an embodiment of the present disclosure. FIG. 7 is a flowchart illustrating eliminating jitter and noise in a time-sequential waveform signal to generate a processed waveform signal in a cutting tool positioning method according to an embodiment of the present disclosure. FIG. 8 is a flowchart illustrating converting the processed waveform signal into a sinusoidal waveform signal through forward and reverse filtering in a cutting tool positioning method according to an embodiment of the present disclosure.

As shown in FIG. 6, step S15 of FIG. 5 may include step S151: eliminating jitter and noise from the time-sequential waveform signal to generate a processed waveform signal; and step S153: converting the processed waveform signal into a sinusoidal waveform signal through forward filtering and reverse filtering.

In step S151, the signal processing device 12 eliminates jitter and noise from the time-sequential waveform signal to generate a processed waveform signal. For example, the time-sequential waveform signal may be a square wave with an amplitude of 0.75 mm, and the signal processing device 12 may eliminate jitter and noise by filtering, averaging methods, or error correction algorithms to form a processed waveform signal with an amplitude of 1 mm.

In step S153, the signal processing device 12 converts the processed waveform signal into a sinusoidal waveform signal through forward and reverse filtering. For instance, the processed waveform signal may be a square wave, undergoing forward filtering to remove noise and unneeded frequency components. The processed waveform signal is then subjected to reverse filtering to compensate for phase distortion caused by forward filtering, and thereby achieving the effect of zero phase distortion, resulting in a sinusoidal waveform signal (sin wave) that may naturally describe periodic phenomena to form the fundamental waveform signal for signal processing.

As shown in FIG. 7, step S151 of FIG. 6 may include step S1511: determining the relationship between a plurality of measured distance values of the time-sequential waveform signal, a first threshold TH1 and a second threshold TH2; when the determination result in step S1511 is that the measured distance value d is less than the first threshold TH1 and greater than the second threshold TH2, proceeding to step S1513: maintaining an output level unchanged; when the determination result in step S1511 is that the measured distance value d is greater than or equal to the first threshold TH1, proceeding to step S1515: outputting a first voltage level; when the determination result in step S1511 is that the measured distance value d is less than or equal to the second threshold value TH2, proceeding to step S1517: outputting a second voltage level. The first threshold TH1 and the second threshold TH2 may depend on the actual length of each of the plurality of tool holders, such as one-fifth of the length of the tool holder.

Please refer to Formula (1), which may be the calculation formula used by the signal processing device 12 to determine the relationship between the plurality of measured distance values of the time-sequential waveform signal, the first threshold and the second threshold, wherein V_{IN} is the input signal (equivalent to the timing waveform signal), V_{OUT} is the output signal, V_{TH+} is the first threshold, V_{TH-} is the second threshold, V_{OH} is the first voltage level, V_{OL} is the second voltage level, and

$${V}_{OUT}^{i}$$

is the original output signal (equivalent to the output signal of the previous calculation). When the input signal V_{IN} is less than the first threshold V_{TH+} and greater than the second threshold V_{TH-}, the output may be the original output signal

$${V}_{OUT}^{i} ;$$

when the input signal V_{IN} is greater than or equal to the first threshold V_{TH+}, the output may be the first voltage level V_{OH}; when the input signal V_{IN} is less than or equal to the second threshold V_{TH-}, the output may be the second voltage level V_{OL}. For example, the first threshold may be set to 0.1 mm, the second threshold may be set to −0.1 mm, the first voltage level may correspond to 1 mm, and the second voltage level may correspond to −1 mm.

$${V}_{O U T} = \{ \begin{matrix}{V}_{OH} , if {V}_{IN} \geq {V}_{TH +} \\ {V}_{OL} , if {V}_{IN} \leq {V}_{TH -} \\ {V}_{OUT}^{i} , if {V}_{TH -} < {V}_{IN} < {V}_{TH +}\end{matrix} \qquad Formula ( 1 )$$

As shown in FIG. 8, step S153 of FIG. 6 may include step S1531: performing forward filtering on the processed waveform signal to generate a forward filtering result; step S1533: converting the forward filtering result into a reverse time sequence, and performing the forward filtering on the reverse time sequence to generate a reverse filtering result; and step S1535: reversing the reverse filtering result back to normal timing to produce the sinusoidal waveform signal.

In an embodiment, assuming the original signal is x[n], the filter calculation formula is H(z)=B(z)/A(z), and the formula (2) may be obtained, in which y_{f}[n] is the result of forward filtering calculated by the formula (2). After obtaining a plurality of forward filtering results y_{f}[0] [symbol] y_{f}[1] . . . y_{f}[N−1] [symbol] y_{f}[N], the reverse time sequence y_{f_rev}[n] may be generated through the formula (3) and formula (4), wherein N is a positive integer. Then, forward filtering may be performed on the reverse time sequence y_{f_rev}[n], and the final reverse filtering result y_{b}[n] may be obtained using the formula (5), wherein B(z)/A(z) is the filter parameters. Finally, the reverse filtering result y_{b}[n] is inverted again and may be restored to the normal time order to obtain the final filtering result y[n], wherein y[n] smooths the original signal x[n] and eliminates phase delay.

$${y}_{f} [ n ] = B ( z ) / A ( z ) * x [ n ] \qquad Formula ( 2 )$$

$${y}_{f} [ n ] = [ {y}_{f} [ 0 ] , {y}_{f} [ 1 ] , {y}_{f} [ 2 ] , … , {y}_{f} [ N - 1 ] \qquad Formula ( 3 )$$

$${y}_{f \_ rev} [ n ] = [ {y}_{f} [ N - 1 ] , {y}_{f} [ N - 2 ] , … , {y}_{f} [ 0 ] ] \qquad Formula ( 4 )$$

$${y}_{b} [ n ] = B ( z ) / A ( z ) * {y}_{f \_ rev} [ n ] \qquad Formula ( 5 )$$

In an embodiment, the forward filtering and/or reverse filtering may be bandpass filtering, for example, using a Butterworth bandpass filter. The forward filtering and/or reverse filtering may have an order of 1, 2, or 3, a low cutoff frequency of 0.5 Hz and a high cutoff frequency of 1 Hz. In an embodiment, when the sampling rate of the distance sensor is 1 kHz, optimal results may be achieved with a filter order of 2, a low cutoff frequency of 0.5 Hz, and a high cutoff frequency of 1 Hz. However, the filtering parameters of the present disclosure are not limited to the above-mentioned.

After converting the time-sequential waveform signal into a sinusoidal waveform signal in step S15, in step S17 of FIG. 5, the signal processing device 12 determines a position offset of each of the plurality of tool holders according to a plurality of measured peak positions of the sinusoidal waveform signal and a plurality of preset peak positions. The preset peak positions may represent the expected set position of each of the plurality of tool holders, and therefore, by comparing the plurality of measured peak positions obtained from the distance sensing and signal processing with the plurality of preset peak positions, a relative offset of each of the plurality of tool holders from the expected set position may be acquired. For example, the signal processing device 12 may determine the position offset of each of the plurality of tool holders based on the sinusoidal waveform signals as shown in Table 1, and which may store in the controller 13 for subsequent control of the tool holder. Table 1 exemplifies the offsets for seven tool holders, though the number of tool holders in a chain-type tool magazine is not limited to this.

TABLE 1
Position offsets of the plurality of tool holders generated
by the signal processing device 12 (unit: mm)

| Tool holder number | Position offset |
|---|---|
| T01 | 0.132 |
| T02 | 0.324 |
| T03 | 0.467 |
| T04 | 0.124 |
| T05 | 0.216 |
| T06 | 0.173 |
| T07 | 0.445 |

In an embodiment, after the chain-type tool magazine 2 powers on and completes a warm-up cycle, the tool chain performs one full rotation while the distance sensor 11 simultaneously captures the measured distance values. After the measured distance values of a continuous time period processed by the signal processing device 12 to form a time-sequential waveform signal, performing time-sequential signal process to convert into a sinusoidal waveform signal and calculating the peak value of the waveform signal. By comparing the position of measured peak of the sinusoidal waveform signal with standard preset peak, the position offset for each tool holder are computed, and the information is transmitted to the tool holder correction table in the controller 13 for positioning feedback.

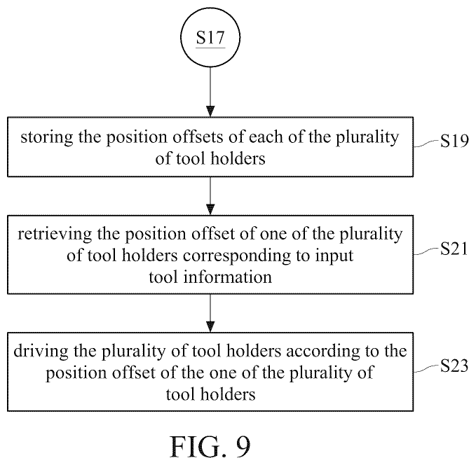

Please refer to FIG. 9, which is a flowchart illustrating using the offset of a tool holder to drive the tool holder in a cutting tool positioning method according to an embodiment of the present disclosure. As shown in FIG. 9, the steps of FIG. 9 may be executed after step S17 in FIG. 5, and include step S19: storing the position offsets of each of the plurality of tool holders. Step S21: retrieving the position offset of one of the plurality of tool holders corresponding to input tool information. Step S23: driving the plurality of tool holders according to the position offset of the one of the plurality of tool holders. The using the offset of a tool holder to drive the tool holder in the cutting tool positioning method of FIG. 9 is applicable for the cutting tool positioning device 1 shown in FIG. 1 and the cutting tool positioning devices shown in FIGS. 3 and 4. The following explanation exemplifies the process of using the offset of a tool holder to drive the tool holder with the cutting tool positioning device 1 shown in FIG. 1.

In step S19, the controller 13 stores the position offset of each of the plurality of tool holders from the signal processing device 12. For example, the position offset may be measured in mm.

In step S21, the controller 13 retrieves the position offset of one of the plurality of tool holders corresponding to input tool information. For instance, when a specific cutting tool number is called by the controller 13, the specific cutting tool number may convert to the actual tool holder number, and applying the correction value from the tool holder correction table to obtain the position offset of the corresponding tool holder.

In step S23, the controller 13 drives the plurality of tool holders according to the position offset of the one of the plurality of tool holders. For example, after obtaining the position offset of the corresponding tool holder, the controller 13 may compensate for the movement distance of the tool holder according to the position offset, thereby enabling the tool holder to move to the ideal position for tool exchange.

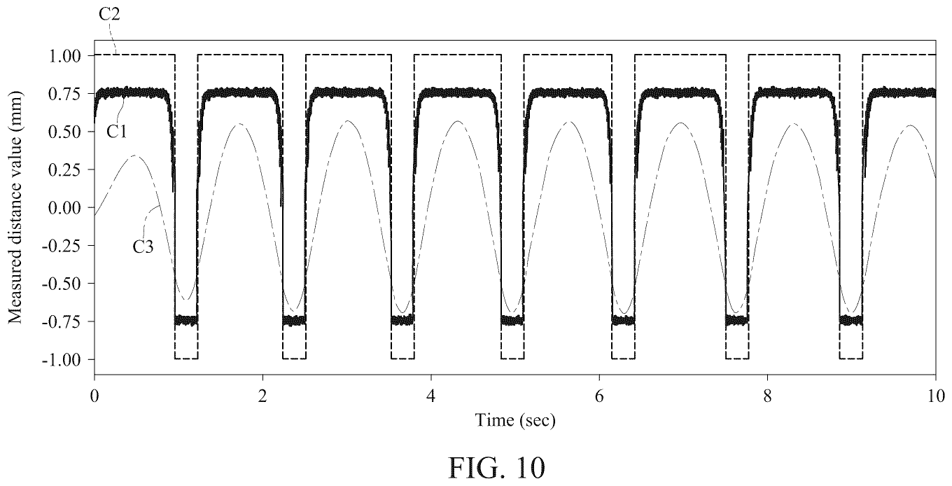

Please refer to FIG. 10 in conjunction with FIG. 6. FIG. 10 illustrates a waveform signal change diagram during the waveform signal transformation process in a cutting tool positioning method of an embodiment of the present disclosure. As shown in FIG. 10, the original time-sequential waveform signal C1 has the measured distance values between −0.75 mm and 0.75 mm. After eliminating jitter and noise, the processed waveform signal C2 is generated, with measured distance values between −1 mm and 1 mm in the form of a square wave. The processed waveform signal C2 is further transformed into a sinusoidal waveform signal C3 through forward and reverse filtering. The sinusoidal waveform signal C3 exhibits a smoother periodic pattern. Specifically, during one complete rotation of the tool magazine system, the measured distance values of sensing data captured by the distance sensor may form the time-sequential waveform signal C1. After the signal processing device eliminates jitter and noise, the processed waveform signal C2 is produced. The signal processing device then applies forward and reverse filtering to generate the sinusoidal waveform signal C3.

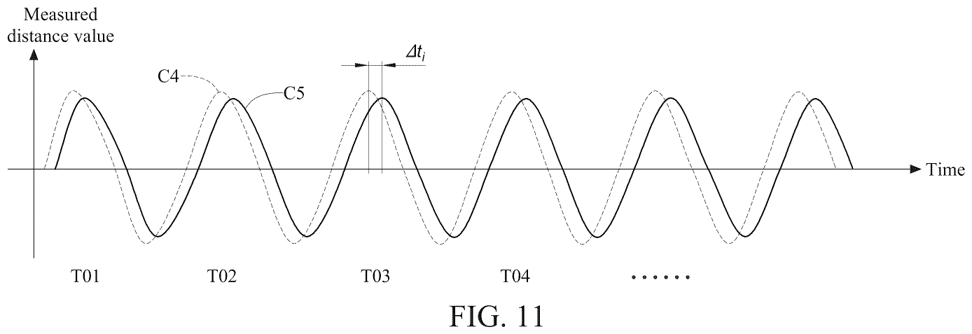

Please refer to FIG. 11 in conjunction with step S17 in FIG. 5. FIG. 11 illustrates a schematic diagram of a waveform signal used in the offset determination step in a cutting tool positioning method according to an embodiment of the present disclosure. As shown in FIG. 11, there is a position offset Δtᵢ between a plurality of measured sinusoidal waveform signals C4 and a plurality of preset sinusoidal waveform signals C5, where T01-T04 correspond to the measured peak positions and preset peak positions of each tool holder, respectively. By using the position offset Δtᵢ corresponding to the peak position of each tool holder, the contents of Table 1 may be obtained. Specifically, after one rotation of the tool magazine system, sinusoidal waveform signals are generated through the aforementioned steps. The measured peak positions of the measured sinusoidal waveform signals C4 are compared with the preset peak positions of the preset sinusoidal waveform signals C5, and the position offset Δtᵢ of each tool holder/peak may be calculated using formula (6), thus completing the offset estimation.

$$Δ {T}_{i} = Δ {t}_{i} * V = ( {t}_{i}^{′} - {t}_{i} ) * V \qquad Formula ( 6 )$$

In Formula (6), Δtᵢ is the time difference of the i-th cutting tool wave peak, V is the chain running speed, ΔTᵢ is the offset of the i-th cutting tool, tⱼ is the standard peak time of the i-th cutting tool, and tᵢ′ is the actual peak time of the i-th cutting tool.

In view of the above description, the cutting tool positioning device and method of the present application may calculate the offset of each of a plurality of tool holders, which equipped with a plurality of cutting tools, respectively, relative to the preset position, thereby enabling the positioning of the plurality of cutting tools in a chain-type tool magazine. Additionally, by storing the offset of the tool holder in a controller and driving the tool holder based on the corresponding offset of the tool holder, the cutting tool positioning device and method of the present application may further correct deviations in the cutting tool change point of the tool holder, allowing for accurate positioning of the cutting tool. This may achieve precise positioning of the cutting tool in the chain-type tool magazine and significantly improve the reliability and durability of the tool magazine system.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A cutting tool positioning device, applicable for a chain-type tool magazine comprising a plurality of tool holders and a base, comprising:
a distance sensor disposed at the base, configured to perform distance sensing along a sensing direction toward the plurality of tool holders, wherein the sensing direction is different from a movement direction of the plurality of tool holders; and
a signal processing device connected to the distance sensor, and configured to obtain a time-sequential waveform signal corresponding to a continuous time period based on sensing data acquired by the distance sensing, convert the time-sequential waveform signal into a sinusoidal waveform signal, and determine a position offset of each of the plurality of tool holders according to a plurality of measured peak positions of the sinusoidal waveform signal and a plurality of preset peak positions.

2. The cutting tool positioning device according to claim 1, wherein the signal processing device comprises:
a hysteresis comparator configured to eliminate jitter and noise from the time-sequential waveform signal to generate a processed waveform signal; and
a bidirectional filter connected to the hysteresis comparator, and configured to convert the processed waveform signal into the sinusoidal waveform signal through forward filtering and reverse filtering.

3. The cutting tool positioning device according to claim 1, wherein the signal processing device is configured to eliminate jitter and noise from the time-sequential waveform signal to generate a processed waveform signal, and convert the processed waveform signal into the sinusoidal waveform signal through forward filtering and reverse filtering.

4. The cutting tool positioning device according to claim 3, wherein the signal processing device is preset with a first threshold and a second threshold, and the signal processing device is configured to maintain an output level unchanged when measured distance value indicated by the sensing data is less than the first threshold and greater than the second threshold, output a first voltage level when the measured distance value is greater than or equal to the first threshold, and output a second voltage level lower than the first voltage level when the measured distance value is less than or equal to the second threshold.

5. The cutting tool positioning device according to claim 4, wherein the first threshold and the second threshold depend on length of each of the plurality of tool holders.

6. The cutting tool positioning device according to claim 3, wherein the signal processing device is configured to perform forward filtering on the processed waveform signal to generate a forward filtering result, convert the forward filtering result into a reverse time sequence, perform the forward filtering on the reverse time sequence to generate a reverse filtering result, and reverse the reverse filtering result back to normal timing to produce the sinusoidal waveform signal.

7. The cutting tool positioning device according to claim 6, wherein the forward filtering is bandpass filtering.

8. The cutting tool positioning device according to claim 6, wherein the forward filtering has an order of 1, 2, or 3, a low cutoff frequency of 0.5 Hz, and a high cutoff frequency of 1 Hz.

9. The cutting tool positioning device according to claim 1, wherein the sensing direction is perpendicular to the movement direction.

10. The cutting tool positioning device according to claim 1, further comprising:
a controller connected to the signal processing device, and configured to store the position offset of each of the plurality of tool holders, retrieve the position offset of one of the plurality of tool holders corresponding to input tool information, and drive the plurality of tool holders according to the position offset of the one of the plurality of tool holders.

11. A cutting tool positioning method, applicable for a chain-type tool magazine comprising a plurality of tool holders and a base, and the method implemented in a form of software or firmware executed after being read by a signal processing device, and comprising:
performing distance sensing along a sensing direction different from a movement direction of the plurality of tool holders toward the plurality of tool holders through a distance sensor;
obtaining a time-sequential waveform signal corresponding to a continuous time period based on sensing data acquired by the distance sensing;
converting the time-sequential waveform signal into a sinusoidal waveform signal; and
determining a position offset of each of the plurality of tool holders according to a plurality of measured peak positions of the sinusoidal waveform signal and a plurality of preset peak positions.

12. The cutting tool positioning method according to claim 11, wherein converting the time-sequential waveform signal into a sinusoidal waveform signal comprises:
eliminating jitter and noise from the time-sequential waveform signal to generate a processed waveform signal; and
converting the processed waveform signal into a sinusoidal waveform signal through forward filtering and reverse filtering.

13. The cutting tool positioning method according to claim 12, wherein eliminating jitter and noise of the time-sequential waveform signal to generate the processed waveform signal comprises:
maintaining an output level unchanged when measured distance value indicated by the sensing data is less than a first threshold and greater than a second threshold;
outputting a first voltage level when the measured distance value is greater than or equal to the first threshold; and
outputting a second voltage level lower than the first voltage level when the measured distance value is less than or equal to the second threshold.

14. The cutting tool positioning method according to claim 13, wherein the first threshold and the second threshold depend on length of each of the plurality of tool holders.

15. The cutting tool positioning method according to claim 12, wherein converting the processed waveform signal into the sinusoidal waveform signal through forward filtering and reverse filtering comprises:
performing forward filtering on the processed waveform signal to generate a forward filtering result;
converting the forward filtering result into a reverse time sequence, and performing the forward filtering on the reverse time sequence to generate a reverse filtering result; and
reversing the reverse filtering result back to normal timing to produce the sinusoidal waveform signal.

16. The cutting tool positioning method according to claim 15, wherein the forward filtering is bandpass filtering.

17. The cutting tool positioning method according to claim 15, wherein the forward filtering has an order of 1, 2, or 3, a low cutoff frequency of 0.5 Hz, and a high cutoff frequency of 1 Hz.

18. The cutting tool positioning method according to claim 11, wherein the sensing direction is perpendicular to the movement direction.

19. The cutting tool positioning method according to claim 11, further executed by a controller connected to the signal processing device, comprising:
storing the position offsets of each of the plurality of tool holders;
retrieving the position offset of one of the plurality of tool holders corresponding to input tool information; and
driving the plurality of tool holders according to the position offset of the one of the plurality of tool holders.
